(19) United States
(12) Patent Application Publication
(10) Pub. No.: US 2005/0086591 A1
(43) Pub. Date: Apr. 21, 2005

(54) System, method, and apparatus for annotating compressed frames

(76) Inventor: Santosh Savekar, Bangalore (Kamataka) (IN)

Correspondence Address: MCANDREWS HELD & MALLOY, LTD, 500 WEST MADISON STREET, SUITE 3400, CHICAGO, IL, 60661, US

(21) Appl. No.: 10/607,363

(22) Filed: Jun. 26, 2003

Related U.S. Application Data
(60) Provisional application No. 60/451,485, filed on Mar. 3, 2003.

(51) Int. Cl. G06F 17/24

(52) U.S. Cl. 715/512

(57) ABSTRACT

Aspects of the present invention are directed to a system, method, and apparatus for annotating decompressed frames from a video sequence. In one embodiment, a data structure comprising a compressed representation of a first frame and a set of parameters is received. The first frame is decompressed and a graphic displaying at least one of the parameters is created. The graphic displaying at least one of the parameters is annotated to the decompressed first frame.

### RELATED APPLICATIONS

This application claims priority to Provisional Application for U.S. Patent, Ser. No. 60/451,485, filed Mar. 3, 2003 by Savekar, entitled “System, Method, and Apparatus for Annotating Compressed Frames”, which is incorporated herein by reference for all purposes.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The MPEG specification provides a standard for compressing video frames by taking advantage of both spatial and temporal redundancy. As a result of the compression techniques, a substantial number of frames are data dependent on other frames. In order to decode a data dependent frame, each frame upon which the data dependent frame is dependent must be decoded first. In some cases, frames are data dependent on other frames which are displayed at later times. As a result, frames are decoded and displayed at different times.

The MPEG standard specifies parameters for the decode time and the presentation time. The parameter indicating the decode time is known as the decoding time stamp (DTS) while the parameter indicating the presentation time is known as the presentation time stamp (PTS). A decoder decoding an MPEG video uses the DTS and PTS to decode and present the frames of the video at the proper times.

The data dependencies complicate certain video functions, particularly video control functions related to personal video recording, such as fast forward, and rewind. Nevertheless, a number of algorithms have developed which provide video control functions. For example, a trick mode scheme allows the user to fast forward, rewind, and pause.

The MPEG video decoder is usually implemented as an off the shelf integrated circuit. The video control functionality is usually implemented as another board-level product. Because the decoding and video control functionality are usually manufactured separately, it is important to debug, test, and verify the video control functionality. Testing the video functionality can involve application of particular video control functions, e.g., reverse, fast forward, etc. However, given the number of frames per second, it is difficult for the human eye to determine the ordering of frames displayed during testing.

Further limitations and disadvantages of conventional and traditional approaches will become apparent to one of skill in the art, through comparison of such systems with embodiments presented in the remainder of the present application with references to the drawings.

### BRIEF SUMMARY OF THE INVENTION

Aspects of the present invention are directed to a system, method, and apparatus for annotating decompressed frames from a video sequence. In one embodiment a data structure comprising a compressed representation of a first frame and a set of parameters is received. The first frame is decompressed and a graphic displaying at least one of the parameters is created. The graphic displaying at least one of the parameters is annotated to the decompressed first frame.

In another embodiment, a decoder for annotating a frame is presented. The decoder includes memory for storing a compressed frame and a set of parameters. A decompression engine decompresses the compressed frames and creates a graphic displaying at least one of the parameters. The decompression engine stores the decompressed frame and the graphic into a frame buffer.

These and other advantages and novel features of the embodiments in the present application will be more fully understood from the following description and in connection with the drawings.

### BRIEF DESCRIPTION OF SEVERAL VIEWS OF THE DRAWINGS

FIG. 1 is a block diagram describing the decompression and annotation of compressed video frames in accordance with an embodiment of the present invention;

FIG. 2 is a flow diagram for decompressing and annotating a compressed video frame in accordance with an embodiment of the present invention;

FIG. 3 is a block diagram describing the decompression and annotation of an MPEG video frame in accordance with an embodiment of the present invention;

FIG. 4 is a block diagram of an exemplary decoder in accordance with an embodiment of the present invention;

FIG. 5 is a block diagram of an exemplary MPEG video decoder in accordance with an embodiment of the present invention;

FIG. 6 is a block diagram describing an exemplary graphical user interface for controlling the mode of operation of a decoder in accordance with an embodiment of the present invention; and

FIG. 7 is a flow diagram for decoding and annotating a compressed video frame in accordance with another embodiment of the present invention.

### DETAILED DESCRIPTION OF THE INVENTION

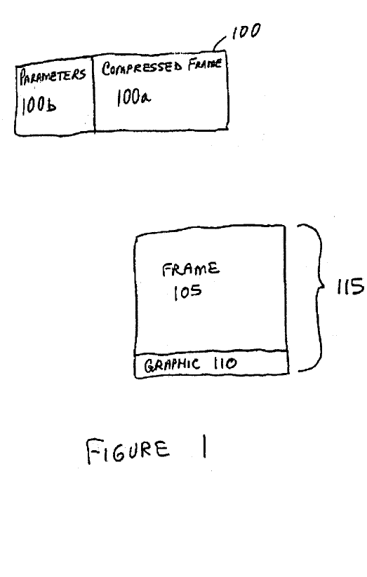

Referring now to FIG. 1, there is illustrated a block diagram describing the decompression and annotation of compressed video frames in accordance with an embodiment of the present invention. Various video compression standards represent the individual frames of the data with a data structure 100. The data structure 100 includes a compressed representation of the video frame 10a, and parameters 100b which are used to decode the compressed representation of the video frame. The compressed representation of the video frame can also include a number of compressed representations of portions of the video frame.

For example, pursuant to the MPEG standard, a video frame is partitioned into 16×16 segments. Each segment is compressed using techniques that take advantage of both temporal and spatial redundancy. The compressed representation of the 16×16 segments includes a set of six structures known as blocks. A video frame is represented by a data structure known as a picture. A picture includes the blocks representing each segment forming the video frame as well as a set of parameters.

Common video standards call for displaying 20-30 video frames per second. Given the fast rate at which frames are displayed, it is often difficult to distinguish different individual frames when displayed as still images. However, visual testing by examining individual frames is important to verify various video flow control functions.

To facilitate the debugging and the verification processor video control functions, a frame is annotated with one or more of the parameters 100b. The compressed representation of the frame 100a is decompressed, thereby resulting in a frame 105. Additionally, a graphic 110 is created which displays at least one of the parameters 100b. The graphic 110 is annotated to the frame 105, thereby forming another frame 115. The graphic 110 can be annotated to the frame 105 as, for example, a header, footer, or margin.

Having some parameters such as Presentation/Decoding Time Stamp of the picture displayed along with the picture helps in testing video control modes. For example, information such as if the picture is a frame/field may be valuable for verifying some video control modes.

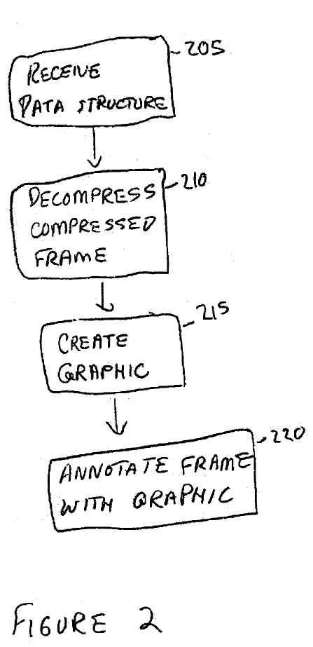

Referring now to FIG. 2, there is illustrated a flow diagram describing the decompression and annotation of a compressed frame 100a. At 205, a data structure is received. The data structure 100 includes a compressed representation of a frame 100a, and a set of parameters 100b(0) . . . 100b(n). At 210 the compressed representation of the frame is decompressed, thereby resulting in a frame 105. At 215, a graphic 110 is created which displays at least one of the set of parameters. At 220, the frame 105 is annotated with the graphic 110, thereby forming another frame 115.

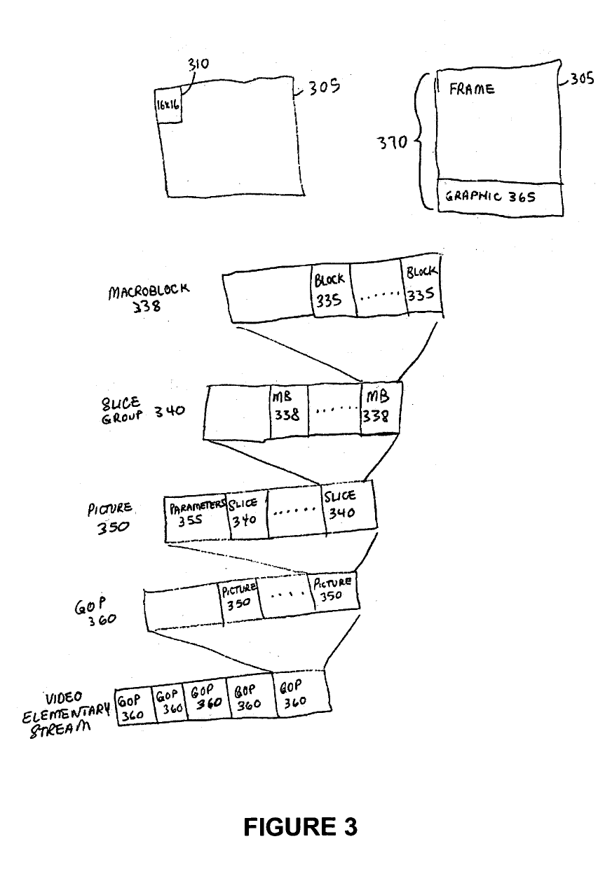

Referring now to FIG. 3, there is illustrated a block diagram describing the decompression and annotation of an MPEG video frame in accordance with an embodiment of the present invention. A frame 305 is partitioned into 16×16 segments 310. Each 16×16 segment 310 is compressed using techniques that take advantage of both temporal and spatial redundancy. The compressed representation of an 16×16 segment includes a set of six structures known as blocks 335. The blocks form a portion of a data structure known as a macroblock 338. Macroblocks 338 associated with a frame 305 are grouped into different slice groups 340. In MPEG-2, each slice group 340 contains contiguous macroblocks 338. The slice group 340 includes the macroblocks representing each block 335 in the slice group 340, as well as additional parameters describing the slice group. Each of the slice groups 340 forming the frame form the data portion of a picture 350. The picture 350 includes the slice groups 340 as well as additional parameters 355. The parameters 355 can include, for example, a decode time stamp and a presentation time stamp. The pictures 350 are then grouped together as a group of pictures 360. The group of pictures also includes additional parameters. Groups of pictures are then stored, forming what is known as a video elementary sequence.

To facilitate the debugging and the verification of video control functions, the blocks 335 of the frame 305 are decompressed and annotated with a graphic 365 which displays at least one of the parameters 355. The blocks 335 are decompressed, thereby resulting in the frame 305. The frame 305 is then annotated with a graphic 365 displaying at least one of the parameters 355.

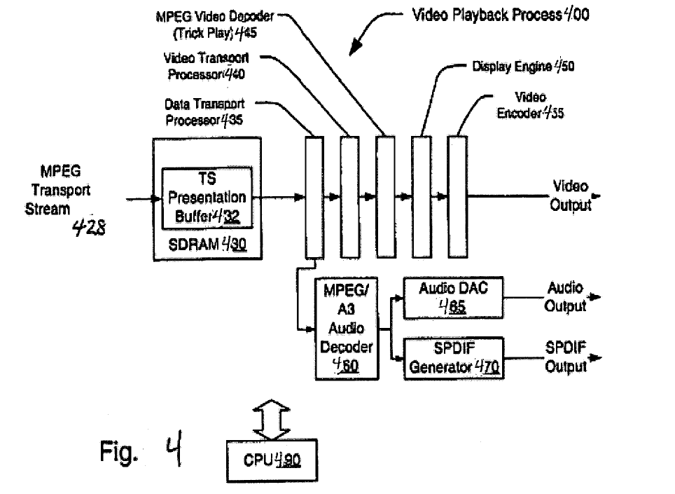

Referring now to FIG. 4, there is illustrated a block diagram of an exemplary decoder in accordance with an embodiment of the present invention. A processor, that may include a CPU 490, reads an MPEG transport stream 428 into a transport stream buffer 432 within an SDRAM 430. The data is output from the transport stream presentation buffer 432 and is then passed to a data transport processor 435. The data transport processor then demultiplexes the MPEG transport stream into it PES constituents and passes the audio transport stream to an audio decoder 460 and the video transport stream to a video transport processor 440. The video transport processor 440 converts the video transport stream into a video elementary stream and provides the video elementary stream to an MPEG video decoder 445 that decodes the video. The audio data is sent to the output blocks and the video is sent to a display engine 450. The display engine 450 is responsible for and operable to scale the video picture, render the graphics, and construct the complete display, among other functions. Once the display is ready to be presented, it is passed to a video encoder 455 where it is converted to analog video using an internal digital to analog converter (DAC). The digital audio is converted to analog in the audio digital to analog converter (DAC) 465.

Additionally, the processor 490 provides a number of video flow control functions, such as rewind and fast forward. The MPEG video decoder 445 is usually implemented as an off the shelf integrated circuit. The processor 490 is usually another board-level product. Because the MPEG video decoder 445 and the processor 490 are usually manufactured separately, it is important to test the video control functionality. Testing the video functionality can involve application of particular video control function, e.g., reverse, fast forward, etc. However, given the number of frames per second, it is difficult for the human eye to determine the ordering of frames and other parameters such as time stamps displayed during testing.

To facilitate the debugging and the verification of video control functions, the MPEG video decoder 445 is configured to selectively annotate a frame 305 with one or more of the parameters 355. The blocks 335 of the frame 305 are decompressed, thereby resulting in a frame 305. Additionally, the MPEG video decoder 445 generates a graphic 365 which displays at least one of the parameters 355. For example, the graphic 365 can comprise a footer printing the presentation time stamp and the decode time stamp. Displaying the presentation time stamp and/or decode time stamp with the frame 305 associated therewith can be useful for debugging, testing, and verifying video control functions. The graphic 365 is annotated to the frame 305, thereby forming another frame 370. The graphic 365 can be annotated to the frame 305 as, for example, a header, footer, or margin. The frame 370 is provided to the display engine 450. The display engine 450 scales the frame 370 for display.

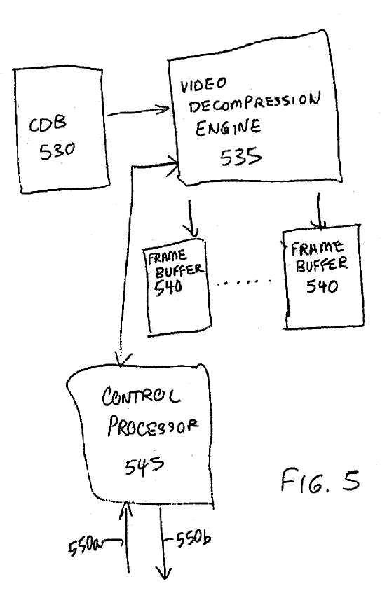

Referring now to FIG. 5, there is illustrated a block diagram of an exemplary MPEG video decoder 445 in accordance with an embodiment of the present invention. The MPEG video decoder 445 comprises a compressed data buffer 530, a video decompression engine 535, frame buffers 540, and a control processor 545.

The MPEG video decoder 445 receives a video elementary stream comprising pictures 350 that include parameters 355 and blocks 335 that are compressed representations of frames 305 and decompresses the frames 305. The video elementary stream is received and stored in a compressed data buffer 530. The video decompression engine 535 accesses the pictures 350 of the video elementary stream and decompresses the frames 305 associated therewith. The frames 305 after decompression are stored in one of a number of frame buffers 540. The frame buffers 540 stores the frames 305 after the frames 305 are decompressed until the frames are displayed.

The video decompression engine 535 is also configured to selectively generate a graphic 365 displaying any one of the parameters 355 associated with a frame 305. Whether the graphic 365 is generated and which parameters 355 are displayed is selectable by the control processor 545. The control processor 545 transmits a signal to the video decompression engine 535 indicating what type of graphic 365 and parameters 355, if any are to be annotated to a frame 305.

Responsive thereto, the decompression engine 535 generates the graphic 365 containing the indicated parameters 355 and saves the graphic 365 with the frame 305 associated therewith in an frame buffer 540. The graphic 365 is stored in the frame buffer 540 as an annotation to the frame 305, such as a header, footer, or margin, thereby causing the frame buffer 540 to store a new frame 370, which comprises the decompressed frame 305 and the graphic annotated 365 to the frame 305.

The type of graphic and parameters, if any, can be selected via a user interface. The user interface is created by control processor 545. The control processor 545 can be accessed via input 550a and output ports 550b. The output port 550b is connectable to an output device, such as a liquid crystal display, or a monitor, while the input port 550a is connectable to an input device, such as a keyboard or a mouse. The input 550a and output ports 550b can be accessible via pins on an integrated circuit. The user interface is output over the output port 550b. The user can make a selection from the user interface by means of an input device, such as a keyboard, or mouse. The user's selection is transmitted to the control processor 545 over the input port 550a.

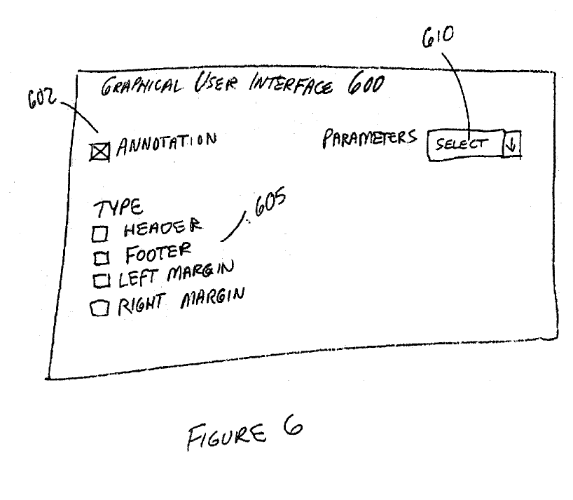

Referring now to FIG. 6, there is illustrated a block diagram of an exemplary graphical user interface 600 for receiving a user selection of a graphic type and parameter for annotating to a frame. The graphical user interface 600 includes a mode select 602 for selecting a mode of operation wherein the frames are annotated with graphics which indicate selectable parameters. The graphical user interface also includes a listing 605 of different types of graphics and a listing of various parameters 610. The type of graphics can include, for example, a header, footer, left margin or right margin. The parameters can include, for example, a presentation time stamp, and decode time stamp. The user can select the type of graphic as well as the parameter displayed therein with an input device such as a mouse or keyboard.

The user's selection of an item in the graphical user interface from an input device triggers an event that is detected by control processor 545. Responsive to receiving the event, the control processor 545 transmits the user's selection to the decompression engine 535.

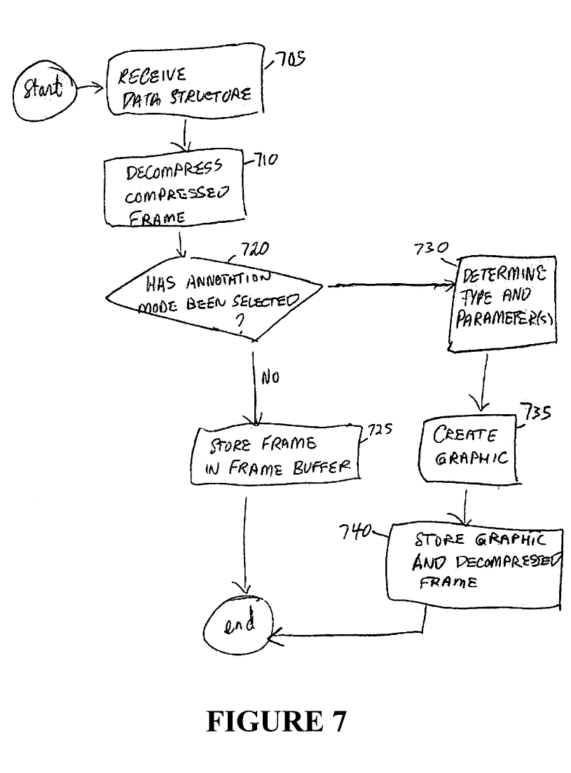

Referring now to FIG. 7, there is illustrated a flow diagram for decompressing and annotating a compressed representation of a frame, such as a picture. At 705, a data structure comprising parameters 355 and compressed representation(s) of a frame 305 is received. The data structure can comprise, for example, a picture 350 comprising parameters 355 and blocks 335. The data structure can be stored in a memory such as a compressed data buffer 530. At 710, the decompression engine 535 decompresses the compressed representation of the frame, e.g., the blocks 335. At 720, the decompression engine 535 determines whether an annotation mode has been selected. If during 720, the annotation mode has not been selected, the decompression engine 535 stores the frame 305 into a frame buffer 540 at 725. If during 720, the annotation mode has been selected, the decompression engine 535 determines the type and parameter(s) selected (730), and creates the type of graphic 365 displaying the selected parameter(s) 355 (735). At 740, the decompression engine 535 stores the frame 305 and the graphic 365 into a frame buffer 540, such that the graphic is annotated to the frame 305, thereby forming another frame 370.

While the invention has been described with reference to certain embodiments, it will be understood by those skilled in the art that various changes may be made and equivalents may be substituted without departing from the scope of the invention. In addition, many modifications may be made to adapt particular situation or material to the teachings of the invention without departing from its scope. Therefore, it is intended that the invention not be limited to the particular embodiment(s) disclosed, but that the invention will include all embodiments falling within the scope of the appended claims.

1. A method for annotating a frame, said method comprising:
receiving a data structure comprising a compressed representation of a first frame and at least one parameter;
decompressing the compressed representation of the first frame;
creating a graphic, said graphic displaying the least one parameter; and
annotating the graphic and the first frame, thereby resulting in a second frame.

2. The method of claim 1, said method further comprising scaling the second frame.

3. The method of claim 1, wherein the at least one parameter comprises presentation time information.

4. The method of claim 1, wherein the graphic is selected from a group consisting of a header, a footer, and a margin.

5. The method of claim 1, wherein the data structure comprises a plurality of parameters and further comprising:
receiving an indication selecting the at least one parameter.

6. The method of claim 5, further comprising:
displaying a graphical user interface, said graphical user interface listing the plurality of parameters; and
wherein receiving the indication further comprises receiving an event, said event indication selecting the at least one parameter.

7. A decoder for annotating a frame, said decoder comprising:
memory for storing a data structure, the data structure comprising a compressed representation of a first frame and at least one parameter;
a decompression engine for decompressing the compressed representation of the first frame and creating a graphic, said graphic displaying the at least one parameter; and
a frame buffer for storing a second frame, the second frame comprising the first frame and the graphic.

8. The decoder of claim 7, further comprising a display engine for scaling the second frame.

9. The decoder of claim 7, wherein the at least one parameter comprises presentation time information.

10. The decoder of claim 7, wherein the graphic is selected from a group consisting of a header, a footer, and a margin.

11. The decoder of claim 7:
wherein the data structure comprises a plurality of parameters; and wherein the decoder further comprises:
a processor for providing an indication selecting the at least one parameter to the decompression engine.

12. The decoder of claim 11, wherein the processor provides a graphical user interface for receiving the selection.

13. A decoder for annotating a frame, said decoder comprising:
memory storing a data structure, the data structure comprising a compressed representation of a first frame and at least one parameter;
a decompression engine connected to the memory; and
a frame buffer connected to the decompression engine, wherein the frame buffer stores a second frame, the second frame comprising the first frame and a graphic created by the decompression engine, said graphic displaying the at least one parameter.

14. The decoder of claim 13, further comprising a display engine connected to the frame buffer, wherein the display engine scales the second frame.

15. The decoder of claim 13, wherein the at least one parameter comprise presentation time information.

16. The decoder of claim 13, wherein the graphic is selected from a group consisting of a header, a footer, and a margin.

17. The decoder of claim 7, wherein the data structure comprises a plurality of parameters and wherein the decoder further comprises:
a processor connected to the decompression engine, wherein the processor provides an indication selecting the at least one parameter to the decompression engine.
